(19) United States
(12) Patent Application Publication
(10) Pub. No.: US 2004/0025705 A1
(43) Pub. Date: Feb. 12, 2004

(54) COFFEE HOT AND COLD FLUSH DEVICE

(76) Inventor: Yuan-Hong Li, Taipei (TW)

Correspondence Address: Yuan-Hong Li, 235 Chung - Ho, Box 8-24, Taipei, TW

(21) Appl. No.: 10/215,323

(22) Filed: Aug. 12, 2002

(51) Int. Cl. A47J 31/00

(52) U.S. Cl. 99/306; 99/304

(57) ABSTRACT

A coffee hot and cold flush device comprises an upper receiving frame, a lower receiving frame, a hopper type earthen bowl, and a liquid collector. At least three support rods are connected the two receiving frame. The upper receiving frame, lower receiving frame and support rods are formed with a space having a size sufficient to receive the liquid collector. A center of the lower receiving frame has a receiving groove for placing the liquid collector. A center of the upper receiving frame is formed with an engaging hole for positioning the hopper type earthen bowl steadily. The hopper type earthen bowl has a bowl groove which is formed with a liquid guide incline. The liquid guide incline is inclined toward a middle liquid outlet. An isolating layer enclosed by filtering cloth is placed upon the liquid guide incline.

### FIELD OF THE INVENTION

The present invention relates to coffee makers, and particularly to coffee hot and cold flush device.

### BACKGROUND OF THE INVENTION

The prior art coffer makers include siphon type coffee makers, filtering type coffee makers, vapor flushing coffee makers, or concentration type coffee makers. All these are operated by using siphon principle. Further a drop type coffee maker is used to filter ice coffee.

However, the prior art coffee maker can not be used both for making ice coffee and hot coffee. Thereby, the user must prepare two kinds of devices for making hot and ice coffees, respectively.

Moreover, many of the prior art coffee makers are complicated in operation so that the price is high. Further these coffee makers have large sizes and thus are inconvenient to be carried out.

Since above defects, the coffee makers can not be widely used. Most people uses soluble coffee packages instead of coffee makers.

### SUMMARY OF THE INVENTION

Accordingly, the primary object of the present invention is to provide a coffee hot and cold flush device, wherein if a user desires to drink coffee, hot water is placed into a bowl groove so that the hot water flows along the periphery of the groove. Then the water passes through a filtering cloth so that the coffee powders are mixed rapidly with hot water and then flows to the liquid guide incline at a lower edge of the hopper type earthen bowl to the liquid outlet. Then the hot coffee liquid falls to the liquid inlet of the liquid collector. At another operation; when the user desires to drink ice coffee liquid, ice blocks are placed upon the coffee powders in the bowl groove. Then the ice water flows through the coffee powders and then mixes with the coffee powders; then the mixing ice coffee liquid flows through the filtering cloth enclosing an isolating layer. Then the ice coffee liquid flows to the liquid guide incline to concentrate to the liquid outlet; then the ice coffee liquid falls into the liquid inlet of liquid collector to be collected therein.

To achieve above object, the present invention provides a coffee hot and cold flush device comprising: an upper receiving frame, a lower receiving frame, a hopper type earthen bowl, and a liquid collector. The upper receiving frame has a configuration corresponding to the lower receiving frame. At least three support rods are connected between the corresponding corners of the upper receiving frame and lower receiving frame. Each support rod has stud holes. The upper receiving frame and lower receiving frame have penetrating holes, respectively so that fixing studs penetrate through the stud holes and penetrating holes to fix the upper receiving frame, lower receiving frame and support rods. The upper receiving frame, lower receiving frame and support rods are formed with a space which has a size sufficient to receive the liquid collector conveniently and easily. A center of the lower receiving frame has a receiving groove for placing the liquid collector. A center of the upper receiving frame is formed with an engaging hole for positioning the hopper type earthen bowl steadily so that the liquid outlet of the hopper type earthen bowl is aligned with the liquid inlet at the top of the liquid collector. The hopper type earthen bowl has a bowl groove; a bowl groove is formed with a liquid guide incline which is inclined toward a middle liquid outlet. An isolating layer enclosed by filtering cloth is placed upon the liquid guide incline.

The various objects and advantages of the present invention will be more readily understood from the following detailed description when read in conjunction with the appended drawing.

### BRIEF DESCRIPTION OF DRAWINGS

FIG. 1 is an exploded perspective view of the present invention.

FIG. 2 is an assembled perspective view of the present invention.

FIG. 3 is a cross sectional view showing the process of making hot coffee according to the present invention.

FIG. 4 is a cross sectional view showing the process of making ice coffee according to the present invention.

FIG. 5 is a cross sectional view showing the process of making coffee in the hopper type earthen bowl according to the present invention.

### DETAIL DESCRIPTION OF THE PREFERRED EMBODIMENT

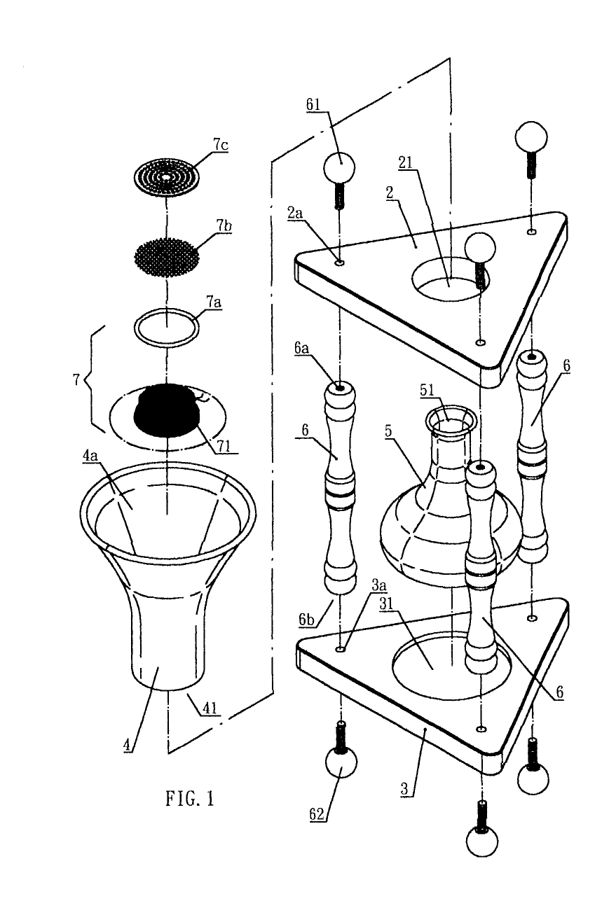

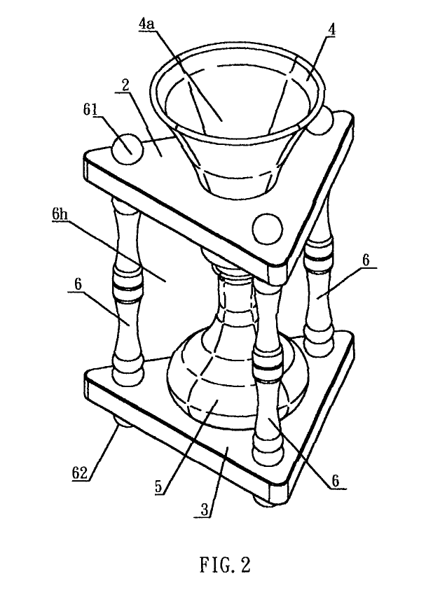

Referring to FIGS. 1 and 2, the coffee hot and cold flush device according to the present invention is illustrated. The coffee hot and cold flush device includes an upper receiving frame 2, a lower receiving frame 3, a hopper type earthen bowl 4, and a liquid collector 5.

The upper receiving frame 2 has a configuration corresponding to the lower receiving frame 3. At least three support rods 6 are connected between the corresponding corners of the upper receiving frame 2 and lower receiving frame 3. Each support rod has stud holes 6a, 6b. The upper receiving frame 2 and lower receiving frame 3 have penetrating holes 2a and penetrating holes 3a, respectively so that fixing studs 61, 62 penetrate through the stud holes 6a, 6b and penetrating holes to fix the upper receiving frame 2, lower receiving frame 3 and support rods 6. The upper receiving frame 2, lower receiving frame 3 and support rods 6 are formed with a space 6h which has a size sufficient to receive the liquid collector 5 conveniently and easily.

The center of the lower receiving frame 3 has a receiving groove 31 for placing the liquid collector 5.

The center of the upper receiving frame 2 is formed with an engaging hole 21 for positioning the hopper type earthen bowl 4 steadily so that the liquid outlet 41 of the hopper type earthen bowl 4 is aligned with the liquid inlet 51 at the top of the liquid collector 5.

The hopper type earthen bowl 4 has a bowl groove 4a. The bowl groove 4a is formed with a liquid guide incline 42 which is inclined toward a middle liquid outlet 41. An isolating layer 7 enclosed by filtering cloth 71 is placed upon the liquid guide incline 42.

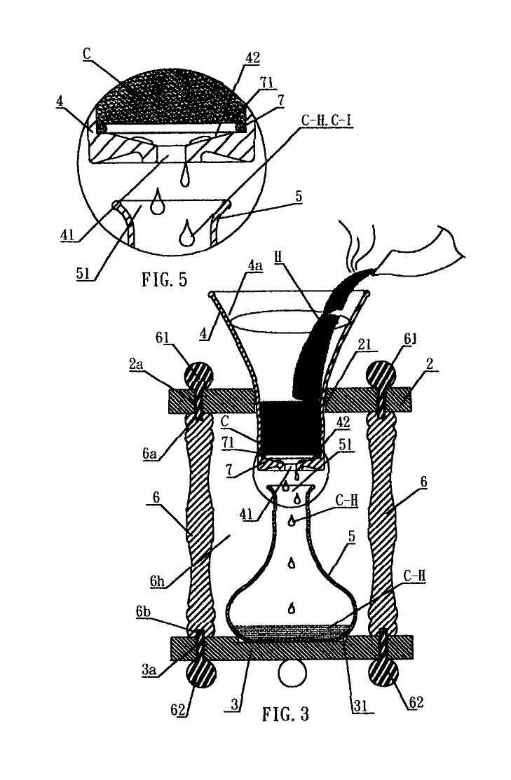

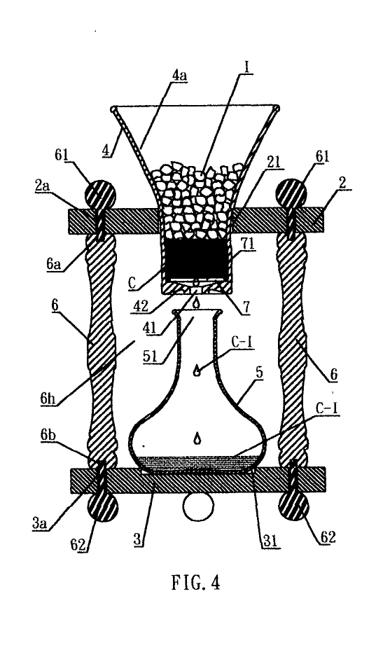

By above structure, referring to FIGS. 3 and 4, the lower section of the hopper type earthen bowl 4 is formed with a receiving space for receiving coffee powders C. If a user desires to drink coffee. Hot water H can be placed into the upper expanding section of the bowl groove 4a (referring to FIG. 3) so that the hot water H flows along the periphery of the groove. Then the water passes through the filtering cloth 71 so that the coffee powders C can be mixed rapidly with hot water to form hot coffee liquid C-H (referring to FIG. 5) and then flows to the liquid guide incline 42 at a lower edge of the hopper type earthen bowl 4 to the liquid outlet 41. Then the hot coffee liquid C-H falls to the liquid inlet 51 of the liquid collector 5 to be collected therein.

When the user desires to drink ice coffee liquid, ice blocks I are placed upon the coffee powders C in the expanding portion of the bowl groove 4a. The ice water will flow through the coffee powders C and then mixes with the coffee powders C. Then the mixing ice coffee liquid C-I will flow through the filtering cloth 71 enclosing the isolating layer 7, as shown in FIG. 5. Then the ice coffee liquid C-I flows to the liquid guide incline 42 at the lower edge of the hopper type earthen bowl 4 to concentrate to the liquid outlet 41 at the middle section. Then the ice coffee liquid C-I falls into the liquid inlet 51 of liquid collector 5 to be collected therein.

After collecting hot coffee liquid C-H or ice coffee liquid C-I, the liquid collector 5 is taken out for use. The operation is conveniently and easily. Moreover, the coffee hot and cold flush device is a portable device.

With reference to FIG. 1, the filtering cloth 71 enclosing the isolating layer 7 is generally used cloth. The inner ring 7a forming the isolating layer 7 is a circular ring. Moreover, the isolating net 7b or porous isolating piece 7c is used to replaced the inner ring 7a.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A coffee hot and cold flush device, comprising: an upper receiving frame, a lower receiving frame, a hopper type earthen bowl, and a liquid collector; characterized in that:
the upper receiving frame has a configuration with respect to the lower receiving frame; at least three support rods are connected between the corresponding corners of the upper receiving frame and lower receiving frame; each support rod has stud holes; the upper receiving frame and lower receiving frame have penetrating holes, respectively, which are positioned corresponding to the stud holes so that fixing studs penetrate through the stud holes and penetrating holes to fix the upper receiving frame, lower receiving frame and support rods; the upper receiving frame, lower receiving frame and support rods are formed with a space which has a size sufficient to receive the liquid collector conveniently and easily;
a center of the lower receiving frame has a receiving groove for placing the liquid collector;
a center of the upper receiving frame is formed with an engaging hole for positioning the hopper type earthen bowl steadily so that the liquid outlet of the hopper type earthen bowl is aligned with the liquid inlet at the top of the liquid collector; and
the hopper type earthen bowl has a bowl groove; a bowl groove is formed with a liquid guide incline which is inclined toward a middle liquid outlet of the hopper type earthen bowl; an isolating layer enclosed by filtering cloth is placed upon the liquid guide incline;
wherein if a user desires to drink coffee, hot water is placed into the bowl groove so that the hot water flows along the periphery of the groove; then the water passes through the filtering cloth so that the coffee powders are mixed rapidly with hot water and then flows to the liquid guide incline at a lower edge of the hopper type earthen bowl to the liquid outlet; then the hot coffee liquid falls to the liquid inlet of the liquid collector; at another operation; when the user desires to drink ice coffee liquid, ice blocks are placed upon the coffee powders in the bowl groove; then the ice water flows through the coffee powders and then mixes with the coffee powders; then the mixing ice coffee liquid flows through the filtering cloth enclosing the isolating layer; then the ice coffee liquid flows to the liquid guide incline to concentrate to the liquid outlet; then the ice coffee liquid falls into the liquid inlet of liquid collector to be collected therein.

2. The coffee hot and cold flush device as claimed in claim 1, wherein the isolating layer is formed by an inner ring, which is then enclosed by the filtering cloth.

3. The coffee hot and cold flush device as claimed in claim 1, wherein the isolating layer is formed by an inner net, which is then enclosed by the filtering cloth.

4. The coffee hot and cold flush device as claimed in claim 1, wherein the isolating layer is formed by an inner porous isolating piece, which is then enclosed by the filtering cloth.
